(19) United States
(12) Patent Application Publication
(10) Pub. No.: US 2006/0179096 A1
(43) Pub. Date: Aug. 10, 2006

(54) System and method for a fused multiply-add dataflow with early feedback prior to rounding

(75) Inventors: Bruce M. Fleischer, Bedford Hills, NY (US); Juergen Haess, Schoenaich (DE); Michael Kroener, Ehningen (DE); Robert K. Montoye, Austin, TX (US); Martin S. Schmookler, Austin, TX (US); Eric M. Schwarz, Gardiner, NY (US); Son Dao-Trong, Stuttgart (DE)

Correspondence Address: CANTOR COLBURN LLP-IBM POUGHKEEPSIE, 55 GRIFFIN ROAD SOUTH, BLOOMFIELD, CT, 06002, US

(73) Assignee: International Business Machines Corporation, Armonk, NY (US)

(21) Appl. No.: 11/055,232

(22) Filed: Feb. 10, 2005

(51) Int. Cl. G06F 7/38

(52) U.S. Cl. 708/494

(57) ABSTRACT

A system for performing floating point arithmetic operations including an input register adapted for receiving an operand. The system also includes computer instructions for performing single precision incrementing of the operand in response to determining that the operand is single precision, that the operand requires the incrementing based on the results of a previous operation and that the previous operation did not perform the incrementing. The operand was created in the previous operation. The system further includes instructions for performing double precision incrementing of the operand in response to determining that the operand is double precision, that the operand requires the incrementing based on the results of the previous operation and that the previous operation did not perform the incrementing.

IBM® is a registered trademark of International Business Machines Corporation, Armonk, N.Y., U.S.A. S/390, Z900 and z990 and other names used herein may be registered trademarks, trademarks or product names of International Business Machines Corporation or other companies.

### BACKGROUND OF THE INVENTION

This invention relates generally to computer systems, and more particularly, to computer systems providing floating-point operations.

One of the key performance factors in designing high performance floating-point units (FPUs) is the number of cycles required to resolve a dependency between two successive operations. For example, an overall latency for a fused multiply-add operation may be seven cycles with a throughput of one operation per cycle per FPU. In this type of pipeline, it is typical that an operation that is dependent on the result of the prior operation will have to wait the whole latency of the first operation before starting (in this case seven cycles).

Currently, some FPUs perform fused multiply-add operations that support limited cases of data dependent operations by delaying the dependent operations until after the rounded intermediate result is calculated. For example, U.S. Pat. No. 4,999,802 to Cocanougher et al., of common assignment herewith, depicts a mechanism for allowing an intermediate result prior to rounding to be transmitted to a new dependent instruction and later corrected in the multiplier. This mechanism supports an intermediate result prior to rounding to be fed back to the multiplier for double precision data.

Further improvements in performance could be achieved by providing early feed back for multiple data types (i.e. single precision and double precision) and by allowing a dependency in both the multiplier input operands, as well as the addend input operand.

### BRIEF SUMMARY OF THE INVENTION

Exemplary embodiments of the present invention include a system for performing floating point arithmetic operations. The system includes an input register adapted for receiving an operand. The system also includes computer instructions for performing single precision incrementing of the operand in response to determining that the operand is single precision, that the operand requires the incrementing based on the results of a previous operation and that the previous operation did not perform the incrementing. The operand was created in the previous operation. The system further includes instructions for performing double precision incrementing of the operand in response to determining that the operand is double precision, that the operand requires the incrementing based on the results of the previous operation and that the previous operation did not perform the incrementing.

Additional exemplary embodiments include a system for performing floating point arithmetic operations. The system includes an input register adapted for receiving a plurality of operands and instructions for performing single precision incrementing of one or more of the plurality of operands in response to determining that the operand is single precision, that the operand requires the incrementing based on the results of a previous operation and that the previous operation did not perform the incrementing. The system also includes computer instructions for performing double precision incrementing of one or more of the plurality of operands in response to determining that the operand is double precision, that the operand requires the incrementing based on the results of the previous operation and that the previous operation did not perform the incrementing.

Additional exemplary embodiments include a method for performing floating point arithmetic operations. The method includes performing single precision incrementing of an operand in response to determining that the operand is single precision, that the operand requires the incrementing based on the results of a previous operation and that the previous operation did not perform the incrementing. The operand was created in the previous operation. The method further includes performing double precision incrementing of the operand in response to determining that the operand is double precision, that the operand requires the incrementing based on the results of the previous operation and that the previous operation did not perform the incrementing.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of an exemplary floating point unit (FPU) that may be utilized by exemplary embodiments of the present invention; and

FIG. 2 illustrates one example of a carry save adder that is utilized by exemplary embodiments of the present invention.

The detailed description explains the preferred embodiments of the invention, together with advantages and features, by way of example with reference to the drawings.

### DETAILED DESCRIPTION OF THE PREFERRED EMBODIMENTS

Exemplary embodiments of the present invention are concerned with optimizing the hardware for dependent operations, where one fused multiply-add operation depends on a prior fused multiply-add operation. A fused multiply-add dataflow implements the equation T=B+A*C where A, B, and C are three input operands and T is the target or result of the multiply-add operation. A may be referred to as the multiplier, C as the multiplicand and B as the addend. The multiply-add operation is considered fused since it is calculated with one rounding error rather than one for multiply, as well as one for the addition operation. In exemplary embodiments of the present invention, the three operands are binary floating-point operands defined by the IEEE 754 Binary Floating-Point Standard. The IEEE 754 standard defines a 32-bit single precision and a 64-bit double precision format. The IEEE 754 standard defines data as having one sign bit that indicates whether a number is negative or positive, a field of bits that represent the exponent of the number and a field of bits that represents the significand of the number. In exemplary embodiments of the present invention, the input operands (i.e. A, B and C) can be either single or double precision (e.g., A and B are single precision and C and T are double precision or any other combination) and the target (T) is defined by the instruction text to be either single or double precision. In addition, exemplary embodiments of the present invention have the capability of handling dependencies for all three operands. An intermediate, un-rounded result may be provided to any of the three operands (i.e. A, B and C).

The seven cycle pipeline of a fused multiply-add dataflow may be labeled using F1, F2, F3, F4, F5, F6, and F7 to indicate each pipeline stage. It is typical that normalization completes in the next to last stage of the pipeline, in this case F6. And, it is typical for the last stage, F7, to perform rounding to select between the normalized result and the normalized result incremented by one unit in the last place. Without feeding back early un-rounded results, a typical pipeline flow of two dependent fused multiply-add operations would occur as follows:

| | Cycles | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| r5 <− r1*r2 + r3 | F1 | F2 | F3 | F4 | F5 | F6 | F7 | | | | | | | |
| r6 <− r5*r2 + r7 | | | | | | | | F1 | F2 | F3 | F4 | F5 | F6 | F7 |

By utilizing exemplary embodiments of the present invention to provide un-rounded data feed back, the pipeline flow of two dependent fused multiply-add operations would occur as follows:

| | Cycles | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| r5 <− r1*r2 + r3 | F1 | F2 | F3 | F4 | F5 | F6 | F7 | | | | | | | |
| r6 <− r5*r2 + r7 | | | | | | | F1 | F2 | F3 | F4 | F5 | F6 | F7 | |

As depicted by the above sequences, the second fused multiply-add operation is started one cycle earlier. As a result, the two fused multiply-add operations are completed in thirteen cycles as opposed to fourteen cycles.

In exemplary embodiments of the present invention, two different schemes are utilized to handle the multiplier operand and addend operand cases. For the feedback to the multiplier operands, the normalized un-rounded result from cycle F6 is fed back to the operand registers (cycle prior to F1). A rounding correction term is formed based on the precision of the output of the first operation (e.g., r5) and the precision of the inputs to the second operation (e.g., r5, r2 and r7). This correction term is added to the partial products in the counter tree. During F7 it is known whether rounding requires incrementation or truncation. This is signaled to the counter tree and the rounding correction term is either suppressed or enabled into the multiplier tree during cycle F1. The rounding correction term can be one of various combinations to be able to handle single or double precision feedback to either operand. Also, the special case of feeding back a result to both multiplier operands has to be considered.

To correct for a dependency on the addend, exemplary embodiments of the present invention feed the normalized exponent of the result early, and, a cycle later feed the rounded result significand back to the next operation. The addend dataflow path is only critical for the exponent difference calculation which determines the shift amount of the addend relative to the product. The significand is not critical and its alignment is delayed by the shift amount calculation to be started in the second cycle. Therefore, the rounded result significand from the last cycle may be fed directly to a latch feeding the second cycle. To be able to do this, an additional bit is utilized in the alignment. Rather than aligning a 53 bit double precision significand, 54 bits are utilized because rounding can increment a 53 bit significand of all ones to a 53 bit significand of one followed by 53 zeros. Since the alignment shift amount is calculated off of a normalized result exponent rather than after rounding, the additional bit of the significand needs to be maintained.

For a 7 stage fused multiply-add pipeline, the exponent is fed back after stage 6 to the input register of stage 1, thus having stage 7 of the prior instruction overlap with stage 1 of the dependent new instruction. In the following cycle, stage 7 feeds a rounded significand of the prior instruction to stage 2 of the new dependent instruction. No shifting alignment of the addend is accomplished in stage 1 and therefore, this stage can be bypassed. Thus, a dependency on an addend operand can be handled by feeding the normalized exponent from stage 6 to stage 1, the rounded significand from stage 7 to stage 2, and preserving an additional bit of the significand to be able to account for a carry out of the 53 bit significand.

For the two multiplier operands, A and C, an exemplary embodiment of the correction is as follows. Let P represent the product, then:
P=A×C

If A=A′+2**−n where n=23 for single precision or 52 for double precision, and A′ is the intermediate truncated result prior to rounding, then, P=A×C=(A′+2**−n)×C=A′×C+2**−n×C.

Therefore, if the intermediate result prior to rounding, A′, is multiplied by C in the multiplier's partial product array, a correction term needs to be added to correct for using A′. This correction term consists of C multiplied by 2**−n. This correction term is simply C shifted either by 23 or 52 bit positions depending on whether A is single or double precision.

If C is the operand that is dependent on the prior operation, and C=C′+2**−n, where C′ is intermediate unrounded result, then:
P=A×C=A×(C′+2**−n)=A×C′+A×2**−n

In this case, the correction term is A shifted by 23 or 52 bit positions.

If both A and C are equal and dependent on the prior operation then:
P=(A′+2**−n)×(C′+2**−n)=A′×C′+A′×2**−n+C′×2**−n+2**(−2n); and
P=A′×C′+A′×2**(−n+1)+2**−2n

For a dependency in the multiplier operands, exemplary embodiments of the present invention create a correction term based on the precision of the operation completing and add this into the partial product array if the rounder increments.

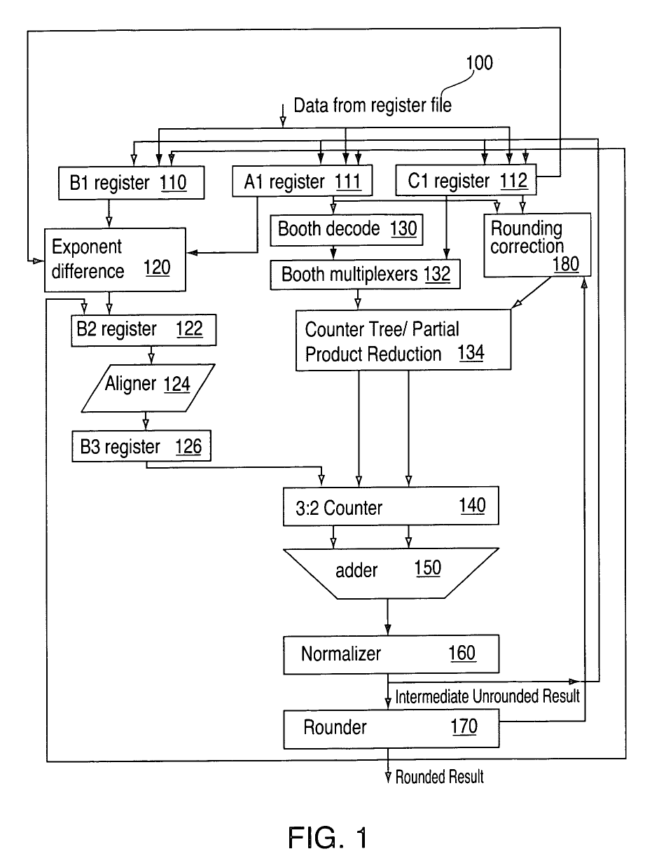

FIG. 1 is a block diagram of a FPU that may be utilized by exemplary embodiments of the present invention to implement a fused multiply add-operation. Data 100 from a register file is provided and input to a B1 register 110, an A1 register 111 and a C1 register 112. In an exemplary embodiment of the present invention, the A1 register 111 and C1 register 112 contain operands that are used in the multiplication portion of the floating point arithmetic operations. The B1 register 110 contains the addition operand. The contents of the A1 register 111 are input to a Booth decoder 130. The Booth decoder 130, Booth multiplexers 132 and counter tree/partial product reduction block 134 may be referred to collectively as a multiplier. The output of the Booth decoder is provided, through Booth multiplexers 132, to the counter tree/partial product reduction block 134. The contents of the C1 register 112 and the A1 register 111 are input to a rounding correction block 180. The contents of the C1 register 112 are also input to the counter tree/partial product reduction block 134 by way of the Booth multiplexers 132.

The contents of the A1 register 111, the B1 register 110 and the C1 register 112 are input to an exponent difference block 120 to determine how to align the inputs to the adder 150 in the aligner 124. The output of the exponent difference block 120 is input to a B2 register 122, and the content of the B2 register 122 is input to an aligner 124. The aligner 124 may be implemented as a shifter and its function is to align the addition operand with the result of the multiplication performed in the multiplier 134. The aligner 124 provides an output that is stored in a B3 register 126. The contents of the B3 register 126 are input to a 3:2 counter 140.

The counter tree/partial product reduction block 134 provides two partial product outputs that are input to the 3:2 counter 140. The 3:2 counter 140 provides output to an adder 150. The output of the adder 150 is input to a normalizer 160 for normalization. The output from the normalizer 160 is input to the rounder 170 for rounding. In addition, the output from the normalizer 160, an intermediate unrounded result, may be used as input to the C1 register 112, the A1 register 111 and/or the B1 register 110. The output from the normalizer 160 is input to the rounder 170 for rounding. The rounded result is output from the rounder 170. The rounder 170 outputs a signal to indicate whether or not an increment is needed for rounding. This indicator signal from the rounder 170 is input to the rounding correction block 180 for input to the counter tree/partial product reduction block 134. In addition, the rounded result may be input to the B2 register 122, the A1 register and/or the C1 register 112.

In exemplary embodiments of the present invention, the logic in the rounding correction term output from the rounding correction block 180 is calculated by the following formulas. The rounding_correction variable is added to the result of A×C to correct for the fact that A and/or C may not be rounded. DP_TARGET is a switch that is set to one when the target, or result, is to be expressed in double precision and the switch is set to zero when the target is to be expressed in single precision. A is the input data stored in the A1 register 111, B is the input data stored in the B1 register 110, and C is the input data stored in the C1 register 112. BYP_A is a switch that is set to one when A is an intermediate un-rounded result and set to zero otherwise. BYP_C is a switch that is set to one when C is an intermediate un-rounded result and set to zero otherwise. The PP_round correction is added to the partial product to correct for A and/or C not being rounded. The rounder_chooses_to_increment is an indicator from the rounder that indicates whether to truncate or to increment.
Rounding_correction(23:105)<=(Zeros(23:52) & C(0:52)) when ((DP_TARGET and BYP_A and not BYP_C)=‘1’) OR
Rounding_correction(23:105)<=(Zeros(23:52) & A(0:52)) when ((DP_TARGET and not BYP_A and BYP_C)=‘1’) OR
Rounding_correction(23:105)<=(Zeros(23:51) & A(0:52) & ‘1’) when ((DP_TARGET and BYP_A and BYP_C)=‘1’) OR
Rounding_correction(23:105)<=(Zeros(23) & C(0:52) & Zeros(77:105))
when
((not DP_TARGET and BYP_A and not BYP_C)=‘1’) OR
Rounding_correction(23:105)<=(Zeros(23) & A(0:52) & Zeros(77:105)) when ((not DP_TARGET and not BYP_A and BYP_C)=‘1’) OR
Rounding_correction(23:105)<=(A(0:23) & ‘1’& Zeros(48:105)) when ((not DP_TARGET and BYP_A and BYP_C)=‘1’); and
PP_round_correction(23:105)<=(Rounding_correction(23:105)) when (Rounder_chooses_to_increment=‘1’)
else Zeros(23:105);

Note that the 53 bits of A or C can be utilized independent of whether they are single or double precision since for single precision bits 24 to 53 will be zero. In an exemplary embodiment of the present invention, this correction is based on DP_TARGET, BYP_A, and BYP_C first. Once it known whether the rounder is incremented or truncated, then there is an AND gate to suppress or to transmit this correction. The rounding correction block 180 may be implemented as a 6 way multiplexer followed by a 2 way AND gate.

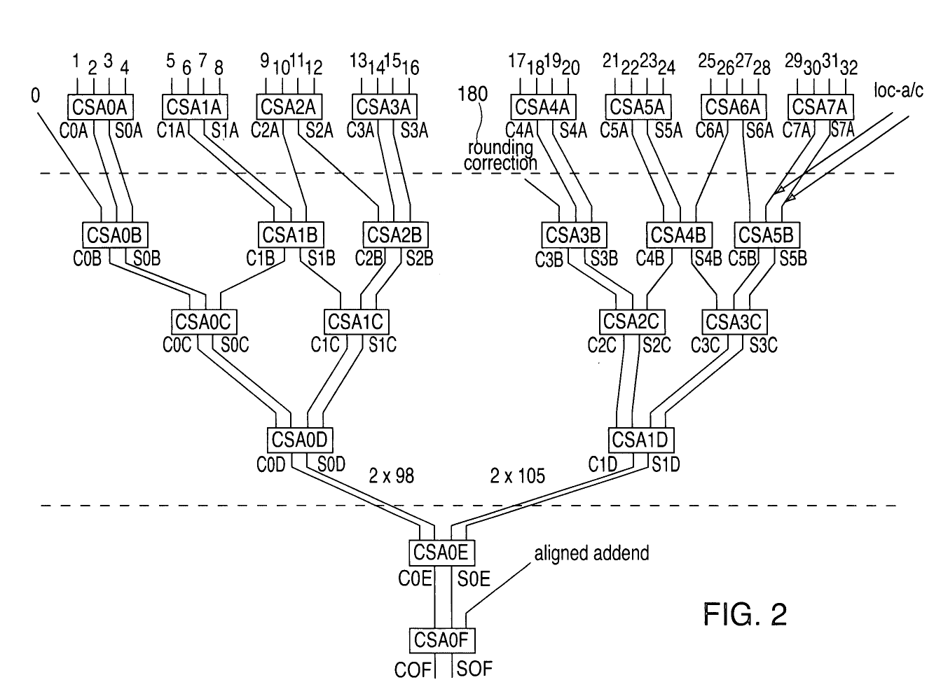

FIG. 2 is an illustration of a carry save adder tree that is part of the multiplier 134 in exemplary embodiments of the present invention. Note that the rounding correction 180 output provides an input to the carry save adder CSA3B. This input is utilized to indicate if the previously computed result was rounded upward. If so, the one is added into the partial products. Because of the propagation delay through the tree, the rounding can be added in a timely manner. Exemplary embodiments of the present invention do not require that the rounding correction 180 be input to the CSA 3 B carry save adder, as the rounding correction 180 may be input to any of the carry save adders in the carry save adder tree (e.g., CSA0E, CSA0D, CSA0C, CSA0B).

Exemplary embodiments of the present invention are described in reference to single and double precision numbers. Other precisions could easily be handled by exemplary embodiments of the present invention, for example a quadword or a double extended precision.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention, can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A system for performing floating point arithmetic operations, the system comprising:
an input register adapted for receiving an operand; and
computer instructions for:
performing single precision incrementing of the operand in response to determining that the operand is single precision, that the operand requires the incrementing based on the results of a previous operation and that the previous operation did not perform the incrementing, wherein the operand was created in the previous operation; and
performing double precision incrementing of the operand in response to determining that the operand is double precision, that the operand requires the incrementing based on the results of the previous operation and that the previous operation did not perform the incrementing.

2. The system of claim 1 wherein the operand is an addend, a multiplier or a multiplicand.

3. The system of claim 1 wherein the operand is an un-rounded intermediate result of the previous operation.

4. The system of claim 1 wherein the incrementing is required for rounding the operand.

5. The system of claim 1 wherein the previous operation is an addition operation.

6. The system of claim 1 wherein the previous operation is a multiplication operation.

7. The system of claim 1 wherein the computer instructions are implemented by one or more of hardware and software.

8. A system for performing floating point arithmetic operations, the system comprising:
an input register adapted for receiving a plurality of operands; and
computer instructions for:
performing single precision incrementing of one or more of the plurality of operands in response to determining that the operand is single precision, that the operand requires the incrementing based on the results of a previous operation and that the previous operation did not perform the incrementing; and
performing double precision incrementing of one or more of the plurality of operands in response to determining that the operand is double precision, that the operand requires the incrementing based on the results of the previous operation and that the previous operation did not perform the incrementing.

9. The system of claim 8 wherein the plurality of operands are an addend, a multiplier and a multiplicand.

10. The system of claim 8 wherein one or more of the operands are an ungrounded intermediate result of the previous operation.

11. A method for performing floating point arithmetic operations, the method comprising:
performing single precision incrementing of an operand in response to determining that the operand is single precision, that the operand requires the incrementing based on the results of a previous operation and that the previous operation did not perform the incrementing, wherein the operand was created in the previous operation; and
performing double precision incrementing of the operand in response to determining that the operand is double precision, that the operand requires the incrementing based on the results of the previous operation and that the previous operation did not perform the incrementing.

12. The method of claim 11 wherein the operand is an addend, a multiplier or a multiplicand.

13. The method of claim 11 wherein the operand is an ungrounded intermediate result of the previous operation.

14. The method of claim 11 wherein the incrementing is required for rounding the operand.

15. The method of claim 11 wherein the previous operation is an addition operation.

16. The method of claim 11 wherein the previous operation is a multiplication operation.
